(19) United States
(12) Patent Application Publication
(10) Pub. No.: US 2011/0041266 A1
(43) Pub. Date: Feb. 24, 2011

(54) Detachable Wheels and Serrated Gripping Surface for Loading Ramp

(76) Inventors: Gene Wyse, Wauseon, OH (US); Randy Gene Wyse, Wauseon, OH (US)

Correspondence Address: Mark A. Hixon;MARSHALL & MELHORN, LLC, 8th Floor, Four SeaGate, Toledo, OH, 43604, US

(21) Appl. No.: 12/791,639

(22) Filed: Jun. 1, 2010

Related U.S. Application Data
(60) Provisional application No. 61/183,043, filed on Jun. 1, 2009.

(51) Int. Cl. B60P 1/43

(52) U.S. Cl. 14/72.5; 414/812

(57) ABSTRACT

A detachable wheel system for a loading ramp is provided. The system comprises wheels which are easily attached for moving the ramp and detached from the ramp for storage. Also, the ramp surface can be provided with a serrated surface for additional grip for users of the ramp.

### CROSS REFERENCE TO RELATED APPLICATION

This application claims the benefit of U.S. provisional patent application No. 61/183,043, filed on Jun. 1, 2009. U.S. 61/183,043 was pending as of the filing date of this application. U.S. 61/183,043 is hereby incorporated by reference as if set forth in its entirety herein.

### BACKGROUND OF THE INVENTION

1. Field of the Invention

The present invention relates to a set of detachable wheels for a loading ramp and a method of utilizing the wheels. More particularly, the present invention includes a pair of wheels which can be easily connected to and detached from a loading ramp, and then stowed for later use. The invention further relates to an improved ramp surface.

2. Summary of Related Art

Loading ramps for vehicles are commonly used to facilitate moving, loading, and transporting a wide variety of items from one elevation to another, particularly from the interior of the vehicle to the ground. Of particular interest, vehicle loading ramps are known and used to load and unload materials from commercial trucks.

These loading ramps are commonly made of metal grating extending between side rails. The grating can be solid, or can consist of a series of individual segments. The ramps commonly include connecting mechanisms to connect the ramps to the vehicle. Typical, these connecting mechanisms comprise at least one hook end or ends designed to fit into and lock in with corresponding receiving notches on the floor of the vehicle at or near the vehicle door.

Generally, the ramps are designed in such a manner as to be stowed underneath the vehicle. Usually structure is provided underneath the vehicle wherein the ramp can be retracted and stowed when the ramp is not in use. When it is time to use the ramp, it can be manually slid from the stowage mechanism and secured to the vehicle for loading or unloading. Upon completion of the use, the ramp is returned to its storage place for transport.

In the case of larger vehicles, it is not uncommon to provide multiple doors for loading and unloading cargo. Typically one cargo door will be at the rear of the vehicle, and one or more cargo doors will be provided in the sides of the vehicle. In this case, it is not uncommon for one ramp to be provided and for the ramp to be totally removable from the vehicle. This ramp can then be moved to any of the vehicle cargo doors for loading and unloading. Due to the length of the ramp, it is generally stored along the length of the vehicle.

One drawback of this system is that the ramp is typically manually transported from the rear of the vehicle to the side cargo doors. This can be difficult, due to the weight of the ramp and the significant length of the ramp, making it awkward to move. Additionally, with the weight and awkwardness of the ramp, there can be safety hazards to the person transporting the ramp. While the addition of wheels to the ramp may alleviate some of the difficulties of moving the ramp from one cargo door to another, this introduces additional difficulties for stowage of the ramp when not in use.

### SUMMARY OF THE INVENTION

According to the present invention, there is provided a set of detachable wheels for a cargo ramp. The wheels are designed in such a manner as to be easily attachable to, and detachable from, the loading ramp. In a preferred embodiment, a single pair of wheels is provided for a loading ramp, so as to create a fulcrum for pivoting the ramp. In another preferred embodiment the ramp includes a “serrated” surface for improved grip on the ramp. In other embodiments of the present invention an additional pair or pairs of wheels can be added.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 shows a view of a ramp according to the present invention;

FIG. 2 shows a view of a wheel assembly connected to a ramp according to the present invention;

FIG. 3 shows a view of a wheel assembly connecting to a ramp according to the present invention;

FIG. 4 shows a view of a longitudinal beam according to the present invention; and

FIG. 5 shows another view of a longitudinal beam according to the present invention.

### DESCRIPTION OF THE PREFERRED EMBODIMENT

In a preferred embodiment of the present invention, the ramp comprises a grated structure, with a pair of lengthwise or longitudinal primary beams connected by a series of cross struts. This type of ramp structure is customary in the art and can be of any conventional type.

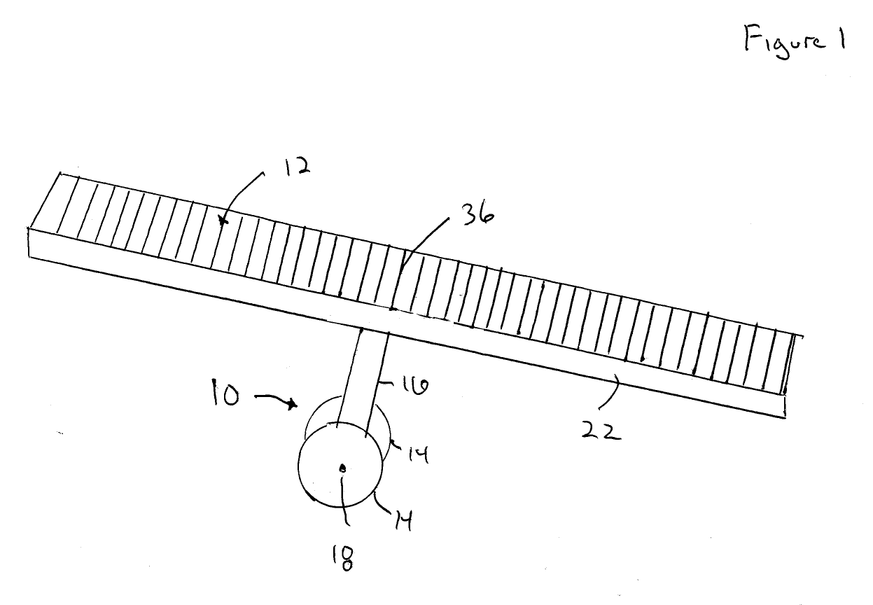

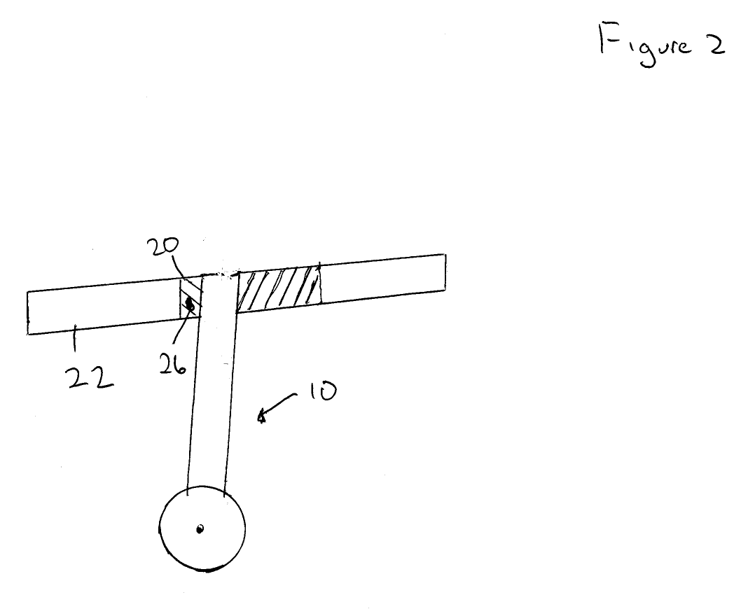

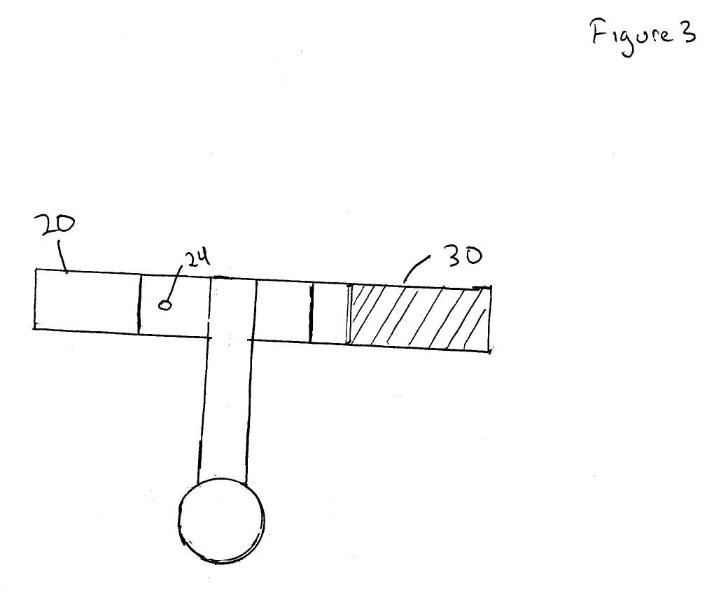

FIG. 1 shows a view of a ramp according to the present invention. The wheel assemblies 10, for use with the ramp 12, each comprise a wheel 14 and a leg 16. The wheel 14 can be connected to the 16 leg by conventional mounting means 8. The wheels 14 are preferably standard commercial wheels and are well known in the art. The length of the leg 16 can be chosen based on the dimensions of the ramp 12, for ease of moving the ramp. As can be noted on FIG. 2, the wheel assembly also comprises a connecting piece 20, connected to the leg, wherein the connecting piece 20 is designed to connect to the primary beam 22 of the ramp 12. At least one hole 24 (see FIG. 3) for a connecting pin 26 is provided in the connecting piece 20, for connecting the wheel assembly 10 to the ramp 12. The connecting piece 20 can be contiguous with or a separately connected piece from the leg 16.

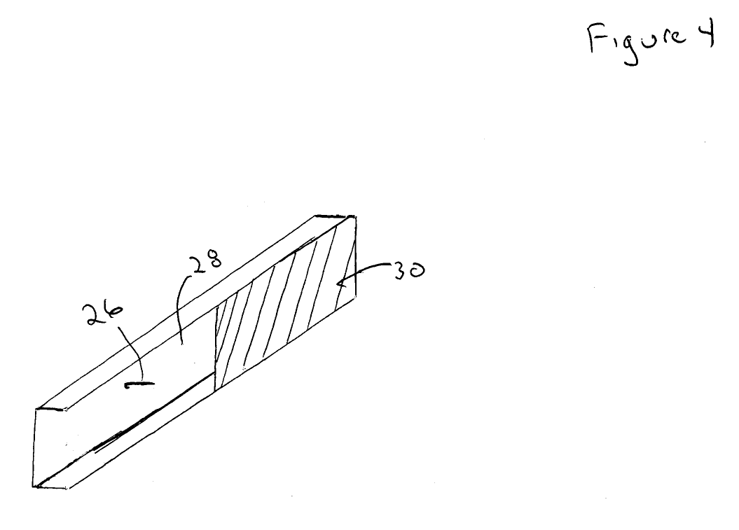

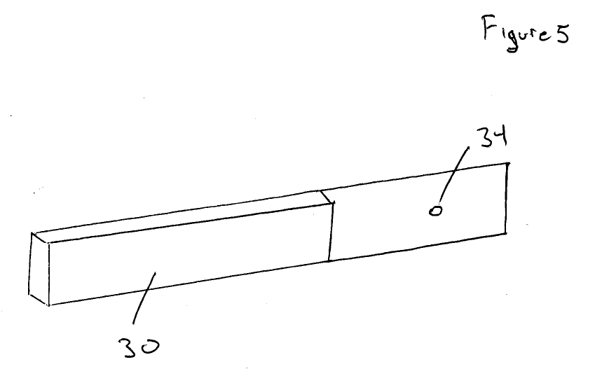

The longitudinal primary beams 22 are each preferably designed with structure to receive the connecting piece of the wheel assembly. As shown in FIG. 4, the longitudinal beam is preferably designed with a U-shaped cross section 28, with the connecting piece 20 designed to fit into the “U”. Additionally, the longitudinal beam 22 is preferably designed with a locking plate 30, wherein the locking plate 30 connects the arms of the “U”, and is positioned so that a space is provided between the locking plate and the base of the “U”, thereby forming a slot 32 to receive the connecting piece of the wheel assembly. The connecting piece can be connected to the longitudinal beam with rivet, bolt, welding or other standard assembly techniques. There is also preferably provided in the longitudinal beam 22 a hole 34 (see FIG. 5) for receiving a locking bolt or pin 26.

In order to secure the wheel structure to the longitudinal beam, a locking pin 26 is provided, which pin is designed to align through the hole 34 in the longitudinal beam 22 and the hole 24 in the connecting piece 20 of the wheel assembly 10 to secure them together.

The invention is designed to utilize a pair of wheel assemblies, with one wheel assembly in each of the longitudinal beams of the ramp. Alternatively, multiple pairs of wheel assemblies can be utilized.

When the ramp is stored on the vehicle the wheel assemblies are preferable disconnected and stored in the truck. Preferably, a mount can be provided on the truck for storing these assemblies, but it is not required. In an especially preferred embodiment of the present invention, the pins which are used to connect the wheel assemblies to the longitudinal beams are also used to secure the wheel assemblies to the mount.

In order to move the ramp, the wheel assemblies 10 are removed from storage and connected to the ramp 12. The connecting piece 20 is slotted into the U-shaped area and is slid under the mounting plate. The bolt 26 is then inserted through the holes 24, 34 in the wheel assembly and the ramp to secure them together. This is preferably done while the ramp is attached to the vehicle. Preferably, the legs of the wheel assemblies are of such a length that they do not touch the ground while the ramp is connected to the vehicle. After connecting the wheels, the ramp can be disconnected from the vehicle, and lowed to where the wheels make contact with the ground. The ramp and then be moved to its new desired position, and the ramp can then be re-secured to the vehicle. As the wheel assemblies are preferably designed so as not to interfere with loading and unloading operations involving the ramp, they can be left on the ramp while the ramp is in use, and only later be removed for storage.

After usage of the ramp is completed, the wheel assemblies can be removed and stored, and the ramp returned to its stowage position under the truck.

Thus, through the present invention, the ease for the operator of moving the ramp is increased, and unnecessary wear on the ramp can be avoided. Also, the provision of the wheels for the ramp can increase the safety of the ramp, as moving the ramp can be cumbersome and unsafe with ramps known in the field.

In a preferred embodiment of a ramp 12 in accordance with the present invention, the longitudinal beams 22 of the ramp can be connected by a series of cross bracers 36. Alternatively, a solid surface can be used to connect the sides 12 of the ramp. In order to improve traction, the ramp 12 can be provided with a serrated surface 38 for additional traction on the ramp. Known ramp surfaces can be very slippery, and subject users to unsafe conditions. In an effort to increase the safety of the ramp, the upper surface of the cross bracers can be serrated in order to increase traction by a user. This improved surface is shown in the attached figures. Preferably, each of the cross braces and have a surface with two or more protruding edges, and a recessed area therebetween. Each of the protruding edges can have a serrated or “toothed” surface, to increase the traction of the surface.

1. A loading ramp with detachable wheels for a vehicle, comprising:
a pair of longitudinal beams connected by structure disposed therebetween;
a pair of wheel assemblies, wherein:
each of said wheel assemblies comprises a leg and a wheel rotatably mounted on the leg;
one of said wheel assemblies is detachably connected to one of the longitudinal beams, and the other of said wheel assemblies is detachably connected to the other of said longitudinal beams, whereby
the wheel assemblies are configured to be mounted on the ramp for moving the ramp and to be removed for storage of the ramp.

2. The loading ramp according to claim 1, wherein the structure disposed between the longitudinal beams comprises a series of connecting braces.

3. The loading ramp according to claim 1, wherein the structure disposed between the longitudinal beams comprises a top surface, and the top surface comprises a serrated surface.

4. The loading ramp according to claim 1, wherein the longitudinal beams each comprise a U-shaped cross section.

5. The loading ramp according to claim 4, comprising a connecting plate connecting the sides of the U-shaped cross section of the longitudinal beams, with the plate disposed a distance from the base of the U-shaped cross section to form an opening therebetween.

7. The loading ramp according to claim 6, wherein:
the leg of each wheel assembly comprises connecting structure with a hole for a connecting pin, and
the connecting structure is designed to be at least partially received by the opening in the U-shaped cross section.

8. The loading ramp according to claim 7, wherein each of the longitudinal beams comprises a hole for a connecting pin.

9. The loading ramp according to claim 8, comprising a pair of removable connecting pins, each of said pins disposed through one of the holes in the longitudinal beams and through the hole in the corresponding connecting structure of the wheel assembly.

10. The loading ramp according to claim 9, wherein the structure disposed between the longitudinal beams comprises a series of connecting braces, each of said connecting braces comprising a top surface, and the top surfaces of at least a portion of the connecting braces comprises a serrated surface.

11. A method of using a loading ramp for a commercial vehicle comprising:
attaching a pair of detachable wheels to the ramp;
removing the ramp from storage on the vehicle so that the wheels contact the ground;
moving the ramp from its stored position to a position where it can be used to unload the vehicle;
moving the ramp back to its storage position, and
removing the detachable wheels from the ramp.

12. A loading ramp for a commercial vehicle, comprising a pair of longitudinal beams connected by a series of connecting braces therebetween, wherein each of the connecting braces comprises a top surface, and the top surface of at least a portion of the connecting braces comprises a serrated surface.

13. The ramp according to claim 12, wherein each of the connecting braces comprises a serrated surface.
